(19) United States
(12) Patent Application Publication
(10) Pub. No.: US 2019/0022662 A1
(43) Pub. Date: Jan. 24, 2019

(54) INCINERATOR ASH WET PROCESSING

(71) Applicant: Best Process Solutions, Inc., Brunswick, OH (US)

(72) Inventor: Timothy F. Conway, Hinckley, OH (US)

(21) Appl. No.: 15/652,599

(22) Filed: Jul. 18, 2017

(51) Int. Cl. B02C 21/00; B02C 17/14; B02C 17/20; B02C 23/38; B02C 23/10; B02C 23/14

(52) U.S. Cl. CPC B02C 21/00; B02C 17/14; B02C 23/14; B02C 23/38; B02C 23/10; B02C 17/20

(57) ABSTRACT

A system and process for reclaiming metals from bottom ash material comprising a pair of rod mills each having an inlet for receiving material and an outlet for discharging material, the outlet of a first rod mill being connected to the inlet of a second rod mill, said rod mills for inclination and power, a circuit for water flow through the rod mills for flushing crushed material and metal from the rod mills to a screen where metal is separated from minerals and water and a processing device for separating minerals from the water of the screen separated minerals and water.

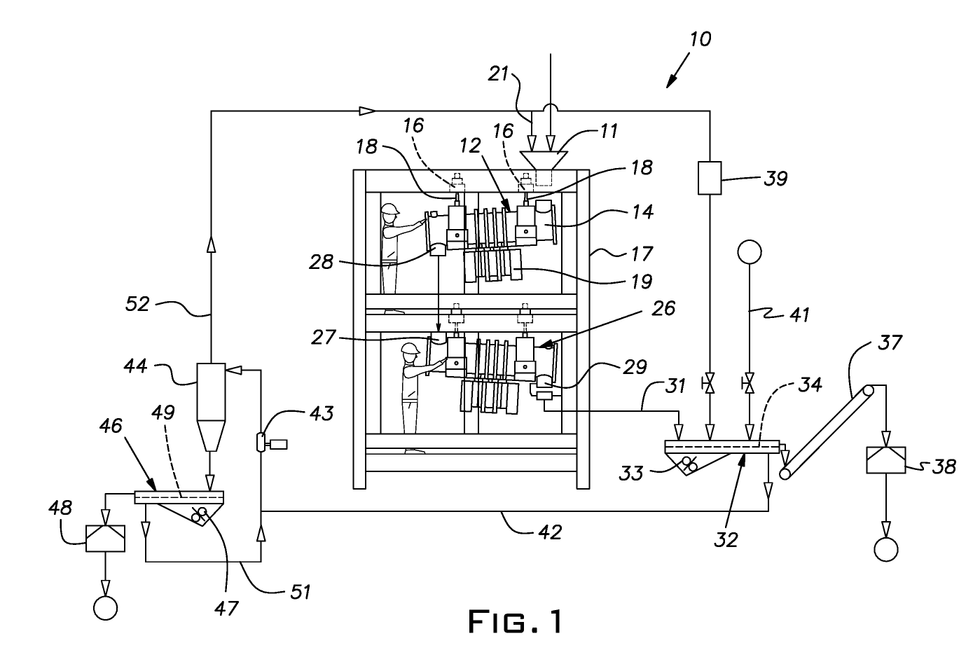

### BACKGROUND OF THE INVENTION

The invention relates to recovery of metals from incinerator bottom ash.

### PRIOR ART

Municipal waste has long been incinerated to reduce its bulk. Ordinarily, the bottom ash produced in the incineration process is disposed of by burying it in a landfill. UK Patent 1,513,511 mentions a percussion crusher shredder being limited to recovery of only ferrous scrap and proposes an alternative wet process for recovering metals from incinerated urban refuse. The disclosed process, apparently, has not met with widespread commercial success.

Millions of tons of bottom ash continues to go to landfills without recovery of the ash metal content in the minus 12 mm fraction, i.e. the fraction of solid particles small enough to pass through 12 mm screen openings. There has long existed a need for an efficient, cost effective and reliable system for recovering bottom ash metal content.

### SUMMARY OF THE INVENTION

The invention obtains a recovered metal product from bottom ash that is remarkably high in metal purity, typically approaching 98 percent metal. In the disclosed wet process, bottom ash concentrate less than 12 mm is fed sequentially through a pair of independently operated rod mills. Water flowing through the rod mills effectively flushes crushed mineral particles as they are produced through the mills, thereby making the milling process especially effective and efficient.

As disclosed, the sequential rod mills are independently suspended and independently actuated. The mills, additionally, for example, can be fitted with bars of different diameter and different number. By varying the operating conditions of each mill separately, the overall performance of a system can be optimized for bottom ash from different sources and of different grades.

### BRIEF DESCRIPTION OF THE DRAWING

The FIGURE is a schematic representation of a metal recovery system embodying the invention.

### DESCRIPTION OF THE PREFERRED EMBODIMENT

An exemplary system 10 and wet process for recovering metals from bottom ash embodying the invention is schematically shown in the FIGURE.

Incinerator bottom ash typically is fed to an inlet 11 of a first rod mill 12. The rod mill, by way of example, can be a cylindrical steel housing of steel sheet with an outside diameter of 24 inches and a length of 6 foot. Steel rods of varying diameter of, for example, ½ to 1½ inch and slightly less in length than the length of the housing interior can be loaded in the housing to occupy some fraction of the housing volume. For example, ⅓ to ½ of the interior housing space can be filled, in a bulk sense, with rods. The rod mill housing 14 is suspended with springs 16 carried in a frame 17. The springs 16 are spaced along the length of the housing 14 and are connected to the housing with support rods 18 of adjustable effective lengths. By adjusting the effective length of the support rods, the inclination of the housing 14 is adjusted. An electric motor 19 fixed on the housing 14 spins an eccentric mass to oscillate the housing about a longitudinal axis with high levels of acceleration. Oscillation of the housing 14 causes rotational displacement of rods within the housing. Rod motion crushes friable components of material introduced to the rod mill 12.

Process water circulating in the system 10 is fed through a line 21 into the rod mill inlet 11 simultaneously with the municipal incinerator bottom ash or the like.

A second rod mill 26 has the same general construction, suspension and vibration inducing motor as that of the first rod mill 12. An inlet 27 of the second rod mill 26 is connected to an outlet 28, preferably directly, of the first rod mill 12 so that material flow through the mills 12 and 26 is serial and no substantive treatment of material passing between the mills is performed.

The rod mills 12, 26 operate to crush friable material including glass, ceramics, rock and minerals contained in ash to small particles, preferably of 1 millimeter or less. The process water flushes the smaller crushed particles through the rod mills 12, 26 as they are produced, thereby exposing the remaining crushable material to the crushing action of the mill rods thus improving throughput of ash material. Metal fragments, being less friable than other components in the ash, pass through the rod mills 12, 26 for the most part without fracturing into small particles.

An outlet 29 of the second mill 26 is connected to a conduit 31 that delivers material to a vibrating screen unit 32 operated by a vibrating motor 33. A screen 34 with openings of between 0.5 mm and 2.5 mm and preferably between 1 mm and 2 mm, for example, conveys metal particles of a size greater than 1 mm, for example, to a discharge conveyor 37 which deposits the metals in a collection site represented by a bin 38.

The recovered metal travelling on the vibrating screen 34 is first rinsed with process water filtered at a filtering system represented at 39. The filtering system can be any suitable commercially available water filter unit. The recovered metal on the screen 34 is thereafter rinsed or flushed with fresh water supplied from a line 41. This second rinse with clean, chemically neutral water, flushes the highly caustic process water off the metals on the screen 34 to avoid subsequent extended oxidation of the metals, particularly aluminum which would otherwise occur if the process water remained to dry on the metals. Process water and suspended mineral particulates passing through the screen 34 are collected and carried off by a line 42 feeding the inlet of a process pump 43. The process pump 43 supplies water with suspended minerals to the inlet of a hydrocyclone 44. Minerals and like solids descending through the hydrocyclone are directed to a vibrating screen unit 46 operated by a vibratory motor 47. The vibratory screen 46, with openings of between 0.25 mm and 3 mm and preferably between 0.25 mm and 1 mm, for example, separates the minerals from water discharged from the bottom of the hydrocyclone 44 and transmits them to a collection area represented by a bin 48. Water passed through a screen 49 of the vibrating unit 46 is conducted to the process pump 43 through a line 51. Water flowing out of the top of the hydrocyclone 44 with a reduced mineral content is supplied through a line 52 to the first rod mill inlet 11 as process water.

The system and process of the invention has demonstrated surprising results measured by high throughput capacity, high purity of recovered metals, low energy consumption, low fresh water consumption, low maintenance and high reliability. A large factor in the surprisingly high performance of the system is believed to be the series arrangement of the separately operated rod mills 12, 26. The rod mills 12, 26 can be independently operated, for example, at different power levels by adjusting motor speed and/or eccentricity of a rotating mass, at different inclinations or declinations with different bar size diameters and with a different number of bars. These variables can be adjusted for the actual composition of the bottom ash being wet processed at any given time.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A system for reclaiming metals from bottom ash material comprising a plurality of rod mills each having an inlet for receiving material and an outlet for discharging material, the outlet of a first of said rod mills being connected to the inlet of a second of said rod mills, said rod mills being independently adjustable for inclination and being independently adjustably powered, a water circuit for establishing water flow through the rod mills for flushing crushed material and metal particles from the rod mills to a screen where metal particles are separated from minerals and water and a processing device for separating minerals from the water of the screen separated minerals and water.

2. A system as set forth in claim 1, including a circuit for conducting water from the processing device to the inlet of an upstream one of said rod mills.

3. A system as set forth in claim 2, wherein the processing device is a hydrocyclone separator.

4. A system as set forth in claim 3, including a mineral separating screen for separating minerals from water discharged from the hydrocyclone separator.

5. A system as set forth in claim 4, including a conduit for conducting water separated from minerals at said mineral separation screen to said circuit.

6. A system as set forth in claim 5, wherein said conduit is connected to said processing device.

7. A system as set forth in claim 1, wherein a source of fresh water for rinsing metal separated on said screen is provided.

8. A wet process for recovering metal from bottom ash comprising feeding ash and water into the inlet of a first rod mill where mineral content of the ash is crushed and the water serves to flush the crushed mineral and metal content through an outlet of the first rod mill into the inlet of a second rod mill, operating the second rod mill with a power level and an inclination independent of the power level and inclination at which the first rod mill is operated, allowing the water to flush crushed material and metal through an outlet of the second rod mill, separating metal from the crushed minerals and water from the second rod mill outlet with a metal separating screen, separating the crushed minerals from water after separation of the metals and returning the water, as process water from which crushed minerals have been separated, to the inlet of the first rod mill.

9. A process as set forth in claim 8, wherein process water is filtered and after filtering is used to rinse metals being separated on said metal separating screen.

10. A process as set forth in claim 9, wherein metals, after being rinsed by filtered process water are rinsed with fresh water of a pH of about 7 to reduce oxidation of the metals.

11. A process as set forth in claim 8, wherein crushed minerals are separated from water after separation of metal, with a hydrocyclone.

12. A process as set forth in claim 11, wherein minerals and water discharged from the hydrocyclone are separated with a fine screen.

13. A process as set forth in claim 12, wherein the fine screen is inclined upwardly from a receiving area and vibrated to remove minerals to a discharge station and remove water from said minerals.
